(19) United States
(12) Patent Application Publication
(10) Pub. No.: US 2026/0044319 A1
(43) Pub. Date: Feb. 12, 2026

(54) SYSTEMS AND METHODS FOR BUILDING A CODE GENERATION AGENT

(71) Applicant: Salesforce, Inc., San Francisco, CA (US)

(72) Inventors: Kexun Zhang, Palo Alto, CA (US); Renze Lou, Palo Alto, CA (US); Huan Wang, Palo Alto, CA (US); Yihao Feng, Austin, TX (US); Zhiwei Liu, Austin, TX (US); Rithesh Murthy, San Francisco, CA (US); Tian Lan, Palo Alto, CA (US); Zuxin Liu, Palo Alto, CA (US); Jiacheng Xu, Sunnyvale, CA (US); Bo Pang, Los Angeles, CA (US); Yingbo Zhou, Palo Alto, CA (US); Shelby Heinecke, San Francisco, CA (US); Weiran Yao, Palo Alto, CA (US); Caiming Xiong, Menlo Park, CA (US); Silvio Savarese, Palo Alto, CA (US)

(21) Appl. No.: 19/028,738

(22) Filed: Jan. 17, 2025

Related U.S. Application Data
(60) Provisional application No. 63/681,524, filed on Aug. 9, 2024.
(60) Provisional application No. 63/697,841, filed on Sep. 23, 2024.

(51) Int. Cl. G06F 8/35; G06F 8/36; G06F 11/3698

(52) U.S. Cl. CPC G06F 8/35; G06F 8/36; G06F 11/3698

(57) ABSTRACT

Embodiments described herein provide a multi-stage rating and re-ranking pipeline for selecting SWE agents for an input issue description. Specifically, a meta-policy may be selected among available agent policies corresponding to a pool of available SWE agents which maximizes the cumulative reward along the trajectory of states (such as status of a file) and actions taken at a series of time steps, and a context of relevant repository information and issue descriptions. By dynamically choosing the most suitable agent policy for each context, the selection pipeline maximizes the expected cumulative reward across all possible contexts. In this way, software issue resolve rate is improved.

### CROSS REFERENCE(S)

The application is a nonprovisional of and claims priority to 35 U.S.C. 119 to U.S. provisional application No. 63/681,524, filed Aug. 9, 2024, and 63/697,841, filed Sep. 23, 2024, both of which are hereby expressly incorporated by reference herein in their entirety.

### TECHNICAL FIELD

The embodiments relate generally to machine learning systems for code generation, and more specifically to building a code generation agent.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, generating programming code to resolve software and hardware issues. Specifically, for network hazards, AI conversation agents can diagnose connectivity problems, suggest corrective actions, and provide step-by-step guidance and/or programming code for implementation to provide network security and stability. In software engineering, AI agents may be used as software engineering tools and techniques for code generation, automated testing, and project management. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

For example, AI agents may be used to generate code programs, referred to as software engineering (SWE) AI agents. For instance, SWE agents may be used to generate code for automatically fixing a bug in a code repository, which is often an extremely challenging task as a bug involve navigating extensive codebases, understanding complex function interactions, detecting subtle errors, and generating the correct fix patch. The large action space of SWE agents, together with long trajectories inevitably may result in the diversity of solutions, as generated by different SWE agents. Therefore, when AI agents are employed to generate programming code, e.g., to resolve real-world software issues based on their descriptions, accuracy, strengths, and/or efficiency of code programs generated by different SWE agents may also vary significantly.

### BRIEF DESCRIPTION OF THE DRAWINGS

FIG. 1A provides an example diagram illustrating an example multi-agent meta-policy SWE agent framework that generates a code patch using diverse solutions from SWE agents, according to embodiments described herein.

FIGS. 1B-1C provide example diagrams illustrating characteristics of different SWE agents, according to embodiments described herein.

FIG. 2A is a simplified diagram illustrating the example framework (depicted at high level in FIG. 1A) for solving a codebase problem, according to embodiments described herein.

FIG. 2B is a simplified diagram illustrating an alternative embodiment of an example code debugging framework with a multi-agent reviewing system for solving a codebase problem, according to embodiments described herein.

FIG. 3 is a simplified diagram illustrating a computing device implementing the code generation described in FIG. 1, according to one embodiment described herein.

FIG. 4 is a simplified diagram illustrating the neural network structure implementing the code generation module described in FIG. 3, according to some embodiments.

FIG. 5 is a simplified block diagram of a networked system 400 suitable for implementing the code generation framework described in FIGS. 1-3 and other embodiments described herein.

FIG. 6 is an example logic flow diagram illustrating a method of automatically generating a code program for a task request based on the framework shown in FIGS. 1-5, according to some embodiments described herein.

FIG. 7 provide example performance results of the data experiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “SWE agent” may refer to any LLM-based system that generates patches to solve issues in a code base, e.g., an instance in SWE-Bench. While the specific implementation varies, a typical SWE agent usually gives their underlying LLM several tools in the form of callable functions to navigate through the code base, find relevant context, edit files, and run tests. The workflow of SWE agents involves multiple LLM calls, each taking some or all outputs from previous steps as input.

### Overview

LLMs may be used as chatbots to conduct human-like conversations. These systems can also autonomously execute actions in both real-world and digital environments. For example, software engineering (SWE) AI agents, a specialized subset of AI agents may utilize generative capabilities of LLMs with software engineering tools and techniques for code generation, automated testing, and project management. Such SWE agents may utilize methods like such as spectrum-based fault localization and abstract syntax tree (AST) analysis, along with code generation, to identify and rectify software issues.

For example, an example task in software engineering is to resolve issues raised by developers. SWE-Bench curates instances of this task by collecting successfully resolved issues from open-source repositories such as Github. Each instance in SWE-Bench consists of a textual issue description, a version of the repo just before the issue was resolved, and (hidden) unit tests that went from fail to pass after the human-written patch. To resolve an instance, the SWE agent is required to generate a patch that can pass these unit tests. For example, an SWE agent usually gives their underlying LLM several tools in the form of callable functions to navigate through the code base, find relevant context, edit files, and run tests. The workflow of SWE agents often involves multiple LLM calls, each taking some or all outputs from previous steps as input.

For instance, SWE agents may be used to generate code for automatically fixing a bug in a code repository, which is often an extremely challenging task as a bug involve navigating extensive codebases, understanding complex function interactions, detecting subtle errors, and generating the correct fix patch. The large action space of SWE agents, together with long trajectories inevitably result in the diversity of solutions, as generated by different SWE agents. Accuracy, strengths, and/or efficiency of code programs generated by different SWE agents may also vary significantly. For instance, some SWE agents excel in code generation but lack proficiency in debugging, while others are adept at managing project workflows but struggle with creative problem-solving.

In view of the need for improve code generation performance in resolving software issues, embodiments described herein provide a multi-stage rating and re-ranking pipeline for selecting SWE agents for an input issue description. Specifically, a meta-policy may be selected among available agent policies corresponding to a pool of available SWE agents which maximizes the cumulative reward along the trajectory of states (such as status of a file) and actions taken at a series of time steps, and a context of relevant repository information and issue descriptions. By dynamically choosing the most suitable agent policy for each context, the selection pipeline maximizes the expected cumulative reward across all possible contexts. In this way, software issue resolve rate is improved.

For example, in one implementation, for each task query, a meta learning framework may be adopted to iteratively select the most suitable SWE agent to generate the next-step code program for the next-step action based on the current state of the environment. During this dynamic process, an LLM may be used to generate a score for each candidate code patch generated by a respective SWE based on a number of criteria such as an explainability of the original text issue, a context explanation level, a location explanation level, a conflict detection.

Embodiments described herein further provide a code debugging framework with a feedback mechanism for optimizing candidate code snippet generated for debugging software issues. The code debugging framework incudes a fault localization component and a code modification component, both implemented by LLM agents. The fault localization component is configured to select an identified code snippet that likely causes a software issue from a code repository, and the code modification component is configured to generate a replacement code snippet of the identified code snippet to resolve errors. Specifically, the code modification component includes a planning agent for generating an instruction to modify the identified candidate code snippet and a coding agent for generating the code for the replacement code snippet.

Different from existing technologies, the code modification component also includes a multi-agent reviewing component. The multi-agent reviewing component includes a context reviewer and a test cases reviewer, both implemented by LLM agents. The context reviewer is caused to determine a first feedback message, which includes whether the replacement code snippet can cause a negative impact to the code repository. The test cases reviewer is caused to generate user situations and/or tests cases to test the validity/performance of the replacement code snippet. The test cases reviewer may generate a second feedback message, which includes the performance of the replacement code snippet on the user situations and/or test cases. The context reviewer and the test cases reviewer then transmit the feedback messages to the planning agent such that the planning agent can update the instructions to further optimize the replacement code snippet.

In this way, by providing a feedback mechanism, including feedback messages from multiple agents on the new replacement code snippet, the SWE agent framework may generate and/or update the replacement code snippet based on additional information of the environment, e.g., the code repository. The replacement code snippet can be optimized effectively with minimized risk to the code repository and overall functionality of the corresponding software. Therefore, with improved performance on code debugging, neural network technology in code generation, such as code generation for issue diagnostics, is improved.

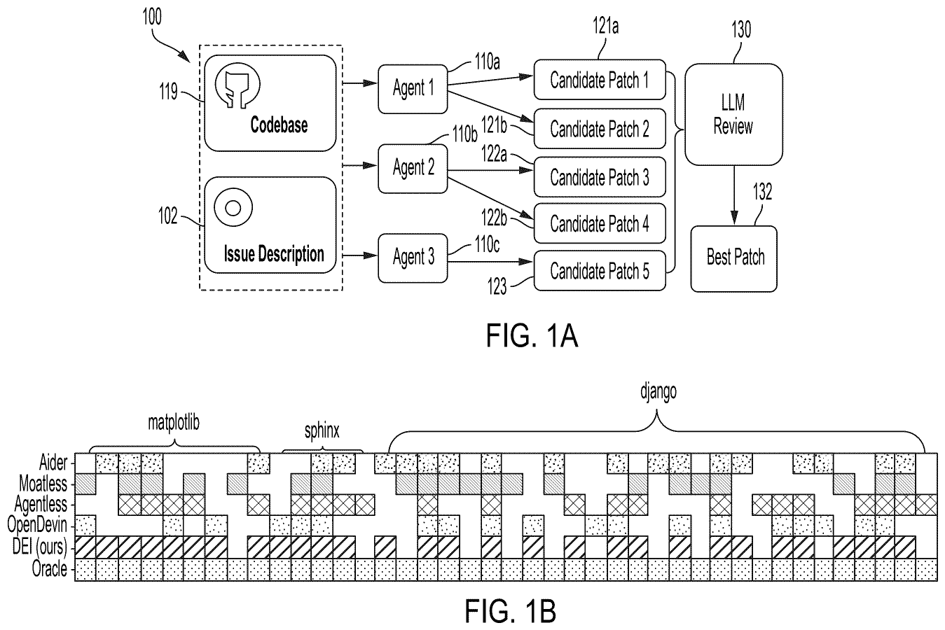

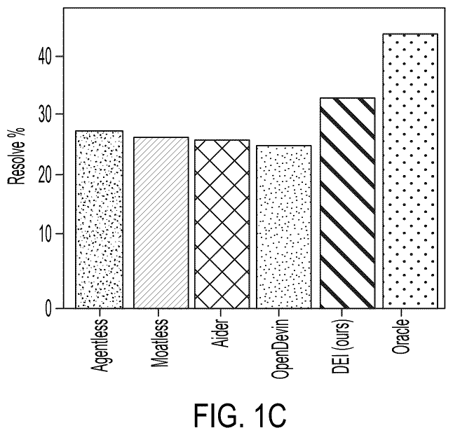

FIG. 1A provides an example diagram illustrating an example multi-agent meta-policy SWE agent framework 1 (“Diversity Empowered Intelligence” (DEI)) 100 that generates a code patch 132 using diverse solutions from SWE agents, according to embodiments described herein. An SWE agent (e.g., 110a-110c) may retrieve a code patch from a codebase 119 (e.g., Github, etc.) in response to a technical problem description 102. Even in response to the same problem description 102, different SWE agents may exhibit different characteristics when generating code patches to a task description. For example, FIGS. 1B-1C provide example diagrams illustrating diverse characteristics of code patches generated by different SWE agents in response to the same task query, according to some embodiments described herein. For example, a large action space of SWE agents, together with long trajectories, inevitably result in the diversity of Github issue solutions, as shown in FIGS. 1B-1C. As shown in FIG. 1B, different SWE agents (e.g., Aider, Moatless, Agentless, Open Devin, and DEI 100 shown in FIG. 1A, a human oracle, etc.) resolve very different sets of issues, as illustrated by the different grids. The diversity in coverage may be caused by different structure and skill sets each SWE has been trained with. For instance, OpenDevin (Wang et al., Opendevin: An open platform for ai software developers as generalist agents. arXiv preprint arXiv:2407.16741, 2024) explicitly instructs an underlying LLM to first replicate the bug in an issue and executes its replication in a development workspace to provide feedback for its generated patches. Other agents like Moatless Tools and Agentless (Xia et al., Agentless: Demystifying LLM-based software engineering agents. arXiv preprint arXiv:2407.01489, 2024) do not actually execute code in the issue-specific repository.

With reference back to FIG. 1A, the DEI framework 100 may utilize the variety in SWE agent capabilities to generate code patches based on the strengths of diverse agents. For example, the DEI framework 100 comprise a multi-agent ensemble system of SWE agents 110a-110c, which may be housed at different remote servers accessible through different application programming interfaces (APIs). Each agent 110a-110c may generate (retrieve) a code patch candidate 121-123 in response to the same problem description 102. To enhance diversity, the same agent may be operated to retrieve different candidate patches at different inference instances, e.g., agent 110a may generate candidate patches 121a-b, agent 110b may generate candidate patches 122a-b, and/or the like.

In this way, different types of diversity among SWE agents 110a-110c may be reflected into the code patch 132. For example, intra-agent diversity refers to the degree to which different runs of the same agent solve different problem instances. It is most likely from the non-determinism of the underlying LLM due to sampling in decoding and mixture-of-experts architecture. Since the workflow of SWE agents involves multiple steps and LLM calls, a slight difference in an earlier step can easily propagate and result in significant differences in the final outcome. On the other hand, inter-agent diversity refers to the degree to which different agents solve different problem in-stances. Besides sharing the potential causes of intra-agent diversity, inter-agent diversity is also largely because of differences in agent design, including different tools, workflows, and prompts.

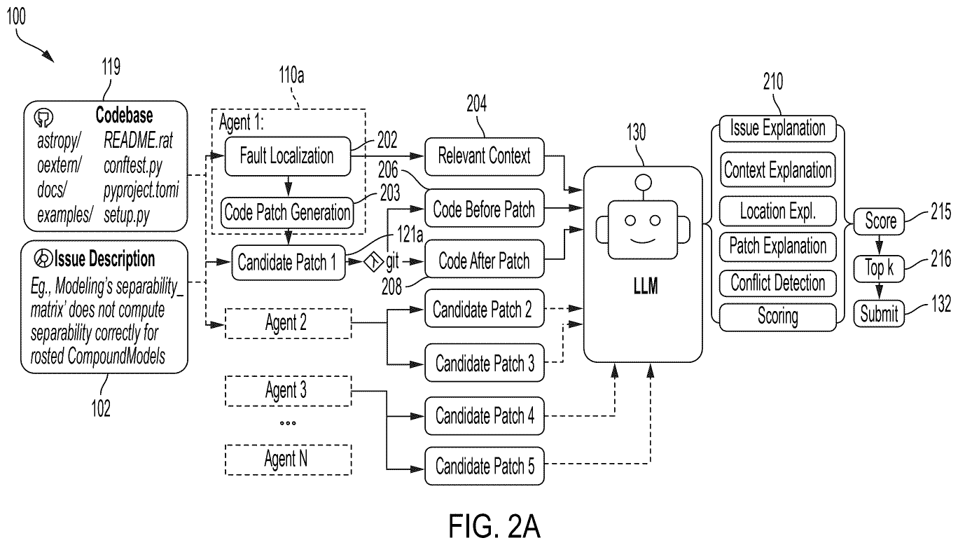

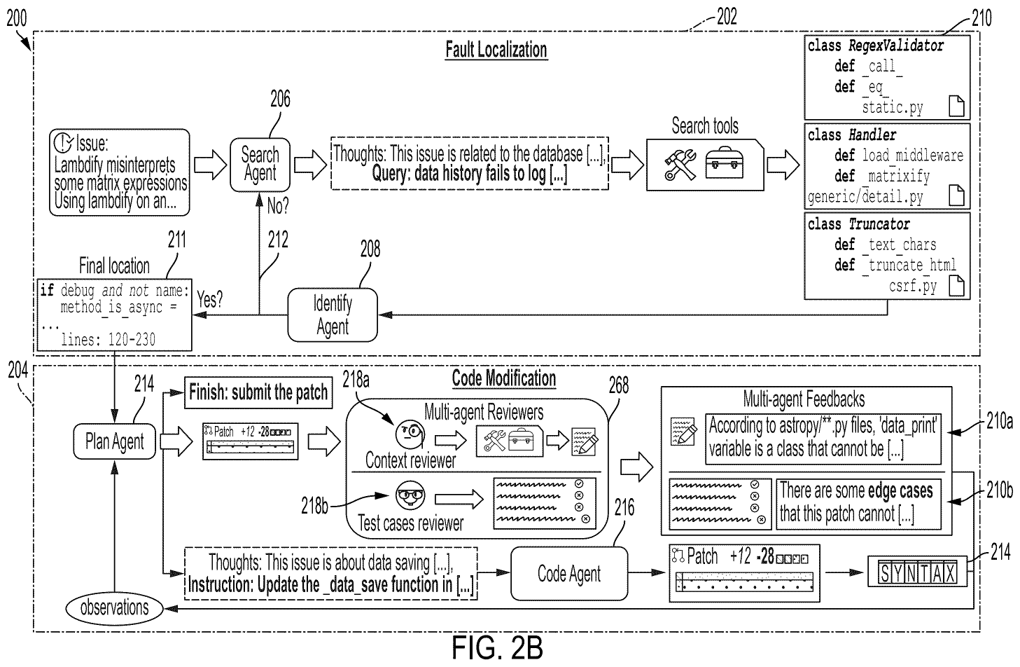

In one embodiment, an LLM 130 may constitute a re-ranking pipeline to review and rank the candidate patches according to criteria further described in relation to FIG. 2. In this way, the best patch 132 may be returned and/or executed at a code environment to resolve the original problem corresponding to the problem description 102.

DEI framework 100 may utilize the diverse characteristics of multiple SWE agents 110a-110c to enhance code patch quality and problem resolve capabilities. In FIG. 1B, DEI framework 100 exhibits a wider coverage of different types of issues than existing SWE agents. FIG. 1C shows that the DEI framework 100 exhibit a higher resolve rate (to software issues) than existing SWE agents, though still lower than a (human) oracle.

In one embodiment, LLM 130 may comprise multiple rounds of reviewing, e.g., i) Context Reviewer: instead of letting the agent system solely access the buggy code as the context, another agent role to retrieve more relevant context from the code base and to see if the current patch solution has facilities with respect to more relevant code provided; ii) Test Cases Reviewer: similarly, another LLM agent may evaluate about any possible use cases that are highly related to the problem description 102 but the current patch solution might fail at, thus ensuring the final solution patch could be comprehensive. Additional details of the multi-agent multi reviewer system may be described in relation to FIG. 2B.

FIG. 2A is a simplified diagram illustrating the example DEI framework 100 (depicted at high level in FIG. 1A) for solving a codebase problem, according to embodiments described herein. As shown in FIG. 2A, in response to a problem/issue description 102, each SWE agent 110a-110c of the framework 100 may retrieve one or more candidate code patches.

In one embodiment, for example, agent 110a may comprise a fault localization module 202 that identifies a location of fault in a code repository, and a code patch generation module 203 to generate a candidate patch 121a. The framework 100 may then examines the code before and after incorporating the candidate patch 121a, e.g., code before the patch 206 and code after the patch 208, along with other relevant contexts generated by the agent 110a (such as supporting document, prior available executions, etc.).

Then, an LLM 130 may generate an output 210 comprising an explanation for the issue, the context, and the patch to justify the patch 121a. With its own explanation, the LLM 130 generates a score 215 for the candidate patch 121a so as to pick the top-scoring ones 216 as more likely to be correct to arrive at the output code patch 132.

For example, as a first step, four inputs to LLM 130 are given for each patch: the issue description 102, relevant context 204 (code snippets identified by an SWE agent as relevant to the issue), code before the patch 206, and code after the patch 208. The inputs are then concatenated to fed to LLM 130. Here, because the entire repository is often too large to fit directly in the context limit of LLMs 130, so relevant context 204 (such as a snippet of most relevant code repository) is used instead to save token costs and help the model focus. Second, the format of a patch is not the easiest for an LLM to read as it switches back and forth between the pre-change code and the changed code, so the code before and after the patch 206, 208 is given separately to the model for easier understanding. In implementation. There might be potential ways of improving the quality of relevant code spans by making them specific to both the issue and the candidate patch, rather than solely dependent on the issue itself.

In one embodiment, as s second step, to help the LLM 130 better “understand” the patch 121a before scoring, LLM 130 is prompted to generate various explanations using the four inputs described as above. The prompt may instruct LLM 130 to generate various explanations in a specified order. The order is decided so that the earlier explanations can also help the later ones. Each explanation is provided in the order they are generated here: 1) Issue explanation explains what the issue is about and what problem it may be causing. 2) Context explanation explains how and why each relevant code span (there might be many of these) is relevant to the issue. 3) Location explanation explains if and why the patch is modifying the correct part of the code that's faulty. 4) Patch explanation explains if and how the patch is fixing the issue. 5) Conflict detection is about checking whether the patch conflicts with other relevant code snippets. LLM 130 may be fed a prompt that instruct LLM 130 to refer back to the earlier explanations while generating the subsequent ones.

In one embodiment, as a third step, based on its own explanations, LLM 130 is asked to give the candidate patch 121a a score from 1 to 10. LLM 130 is provided detailed rubrics of what violations/mistakes lead to higher score deduction and what should only be considered minor violations. For example, if LLM 130 finds the modification location to be wrong, it is considered a serious mistake.

In this way, LLM 130 may function as a code review committee to evaluate each candidate patch 121a by analyzing the state of the code base before and after the proposed changes, in conjunction with the contextual information from the issue descriptions. It produces detailed explanations for each patch, justifying the modifications based on the identified issues, the context, and the specific changes made.

In some embodiments, other methods of code review and scoring, such as rule-based approaches, can be incorporated into DEI framework 100.

In some embodiments, the diverse generation and LLM-evaluation to choose the best code patch 132 in response to a problem description 102 may be iteratively performed to resolve coding and/or technical issues in a real-world software environment. For example, the SWE agent problem may be formulated as a contextual Markov decision process (CMDP) framework, represented by the tuple [symbol] =(S, C, A, R, P, p_0, ρ). Here, S denotes the state space, which encompasses all possible states the agent could encounter, such as the current status of files. The context space, C, includes relevant repository information (e.g., relevant context 204) and issue descriptions (e.g., issue description 102). The action space A, represents all potential represents all potential actions or tools the SWE agent can utilize, such as search or editing. The context-dependent reward function, R:S×A×C → [symbol] , assigns scores based on the actions taken by the agent. For instance, the reward is high if the agent successfully addresses an issue, while it is low if the action results in new bugs in the repository. The context-dependent transition function, P:S×A×C→Δ(S), defines how the state of the repository or information changes following a specific action. The context-dependent initial state distribution is denoted by p₀:C→Δ(S), and ρ∈Δ(C) represents the context distribution.

In one embodiment, given the initial context c˜ρ and initial state s₀˜p₀(⋅|c), at each time step t, each SWE agent 110a-110c follows a policy π:S×C->Δ(A) to select an action at aₜ˜π(sₜ,c) and receives a reward R(sₜaₜ, c). Here, the rewards may be associated with the explanations 210 and/or the score 215. The environment then transitions to the next state sₜ₊₁˜P(⋅|sₜaₜ, c), providing the agent with a new state observation. As the iteration progresses to time T, a sampled trajectory

$$τ := {\{ {s}_{t} , {a}_{t} , {r}_{t} \}}_{t = 0}^{T}$$

is obtained. In the DEI framework 100, assuming the multiple SWE agents 110a-110c may correspond to N agent policies, denoted as {π₁, π₂, . . . , π_{N}}, where each policy is tailored to address a specific context {ρ₁, ρ₂, . . . , ρ_{N}}. The union of these contexts is a subset of the entire context space, i.e., ρ1{ρ₁∪ρ₂∪ . . . ⊆ρ}. A meta-policy, denoted as π_{DEI}, which aims to optimally select among the available agent policies based on the context. The goal of π_{DEI} is thus selected as:

$$■ ( π\_DEI = ■ ( max @ π ) 𝔼 \_ ( c ∼ ρ ) @ ) [ ■ ( 𝔼\_τ @ ) [ ■ ( T @ \sum R ( {s}_{-} t , {a}_{-} t , c ) \vert c ; π ( c ) @ t = 0 ) ] ] \qquad ( 3 )$$

where π(c) denotes the selection of the optimal agent policy from {π₁, π₂, . . . , π_{N}}based on the observed context c. By dynamically choosing the most suitable agent policy for each context, the DEI framework seeks to maximize the expected cumulative reward across all possible contexts.

FIG. 2B is a simplified diagram illustrating an alternative embodiment of an example code debugging framework 200 with a multi-agent reviewing system for solving a codebase problem, according to embodiments described herein.

The framework 200 comprises a fault localization component 202 and a code modification component 204, operatively connected to each other. Each of the fault localization component 202 and the code modification component 204 may be built on one or more LLMs.

Specifically, fault localization component 202 has an input prompt including a problem description 202 of a software issue (“issue”) in natural language and an output of one or more identified code snippets (“Final location”). Code modification component 204 has an input of the identified code snippet(s), and an output 211 of the final code snippet (e.g., the optimized replacement code snippet, shown as “Finish: submit the patch”).

Fault localization component 202 may include a search agent 206 and an identify agent 208, each implemented via a suitable LLM. Search agent 206 may receive the input prompt with the issue description 102 in natural language, and generate a short query that summarizes the issue. The short query may be used, e.g., in a search tool, to retrieve a set 210 of code snippets, e.g., top-K code snippets, that are relevant to the short query from a code repository. Identify agent 208 may receive an input prompt with set 210 and an instruction to check whether the number of identified code snippets 212, e.g., the code snippets in set 210 that exceed a predetermined relevance level to the short query, is equal to or greater than a predetermined number. If the number is equal to or greater than the predetermined number, identify agent 208 may generate a feedback 212 containing an instruction for search agent 206 to stop generating the short query, and identified code snippets 212 are transmitted to code modification component 204. If the number of identified code snippets 212 is less than the predetermined number, identify agent 208 may generate feedback 222 containing an instruction for search agent 206 to re-generate/update the short query, until the number identified code snippets 212 is equal to or greater than the predetermined number.

Code modification component 204 may include a planning agent 214, a coding agent 216, and a multi-agent reviewing component 218, each implemented by an LLM. Planning agent 214 may receive an input prompt including identified code snippets 212, the issue description, and an instruction to generate a plan (e.g., a planning instruction), that briefly describes which of the identified code snippets 212 should be modified and the kind of modifications should be made. Code agent 216 may receive an input prompt including the code snippet determined by planning agent 214 and the plan, and generate a replacement code snippet of the determined code snippet by making a modification to the determined code snippet. The replacement code snippet may be executed for checking syntax errors, such as grammar lining errors. A feedback message 224 may be generated by the execution environment, and may be transmitted to planning agent 214, reflecting the result of the syntax checking. Planning gent 214 may further update the plan based on feedback message 224.

In some embodiments, code modification component 204 further includes a multi-agent reviewing component 218 communicatively coupled to planning agent 214 and coding agent 216, configured to provide additional feedback to planning agent 214 in order to optimize the replacement code snippet. Multi-agent reviewing component 218 may include a context reviewer 218a and a test cases reviewer 218b, each implemented by a suitable LLM. Context reviewer 218a may receive an input prompt including the issue description, the modification made by coding agent 216, a question to context reviewer 218a to determine what negative impact can be done to the code repository after applying the modification, and an instruction to generate a feedback message 220a in response to the question. Meanwhile, test cases reviewer 218a may receive an input prompt including the issue, the modification made by coding agent 216, an instruction to generate one or more test cases that the replacement code snippet may fail at, and an instruction to generate a feedback message 220b reflecting the execution results based on the test cases. Context reviewer 218a and test cases reviewer 218b may respectively send feedback messages 220a and 220b to planning agent 214 to cause planning agent 214 to update/refine the plan, and coding agent 216 to update/refine the modification/replacement code snippet. The feedback loop may stop if planning agent 214 determines the modification is sufficient and/or the number of modifications exceed a predetermined loop number. The latest version of code snippet when the feedback loop stops may be outputted/submitted by code modification component 204 as the final code snippet for the issue.

### Computer and Network Environment

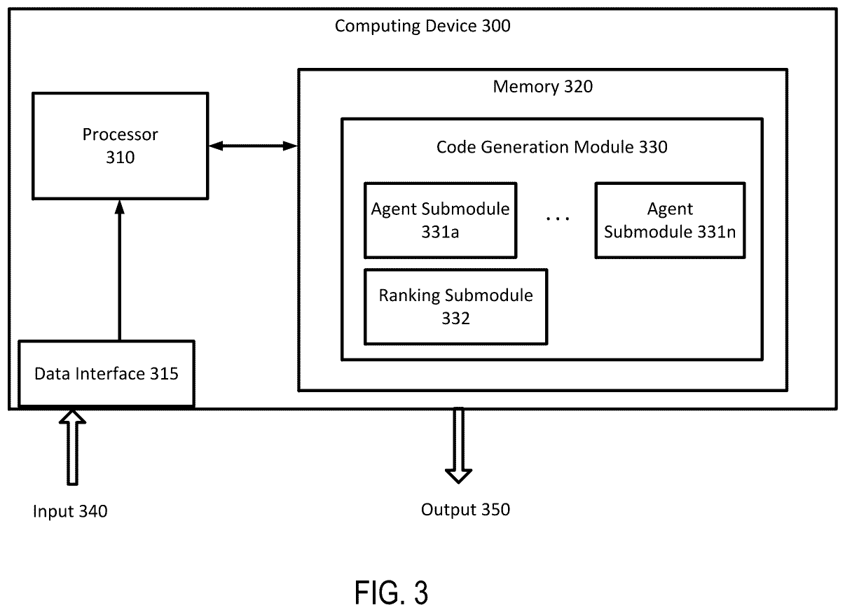

FIG. 3 is a simplified diagram illustrating a computing device implementing the code generation described in FIG. 1, according to one embodiment described herein. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for code generation module 330 that may be used to implement and/or emulate the systems and models, and/or to implement any of the methods described further herein. code generation module 330 may receive input 340 such as an input training data (e.g., issue description and code programs) via the data interface 315 and generate an output 350 which may be an output code program.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as an issue description, from a user via the user interface.

In some embodiments, the code generation module 330 is configured to generate a code patch. The code generation module 330 may further include SWE agent submodule 331a-n, a ranking submodule 332, and/or the like.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

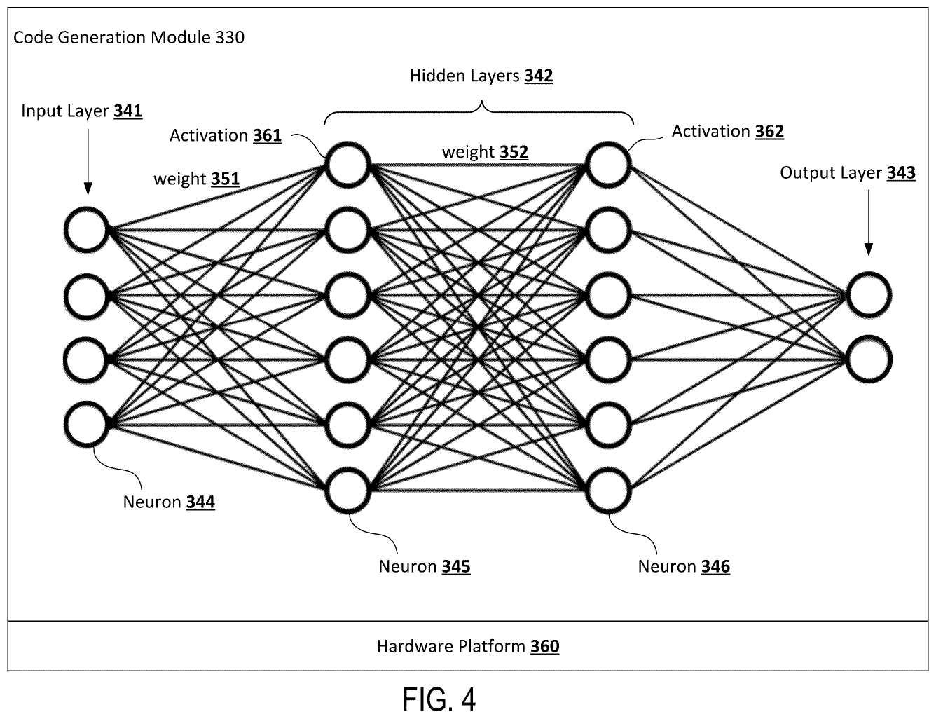

FIG. 4 is a simplified diagram illustrating the neural network structure implementing the code generation module 330 described in FIG. 3, according to some embodiments. In some embodiments, the code generation module 330 and/or one or more of its submodules 331a-232 may be implemented at least partially via an artificial neural network structure shown in FIG. 3. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as a natural language issue description. The number of nodes (neurons) in the input layer 341 may be determined by the dimensionality of the input data (e.g., the length of a vector of the natural language issue description). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3, the code generation module 330 receives an input 340 of issue description and transforms the input into an output 350 of a code patch. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the code generation module 330 and/or one or more of its submodules 331a-232 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be a Transformer based LLM, and/or the like.

In one embodiment, the code generation module 330 and its submodules 331a-232 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the code generation module 330 and its submodules 331a-332 may be implemented by hardware, software and/or a combination thereof. For example, the code generation module 330 and its submodules 331a-232 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

For example, to deploy the ______ABC______ module XXX30 and its submodules XXX31-XXX3NUMSUBMODULES and/or any other neural network models such as ______ described in FIG. ____ onto hardware platform XXX60, the neural network based modules XXX30 and its submodules XXX31-XXX3NUMSUBMODULES may be optimized for deployment by converting it to a suitable format, such as ONNX or TensorRT, to improve performance and compatibility. Next, depending on the size and workload requirements for modules XXX30 and its submodules XXX31-XXX3NUMSUBMODULES, hardware types may be chosen for deployment, e.g., processing capacity, GPU memory size, and/or the like. Frameworks and drivers for the chosen hardware XXX60 frameworks and drivers may thus be installed, such as PyTorch, TensorFlow, or CUDA, to support the hardware platform XXX60. Then, weights and parameters of the ______ABC______ module XXX30 and its submodules XXX31-XXX3NUMSUBMODULES may be loaded to the hardware XXX60. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the ______ABC______ module XXX30 and its submodules XXX31-XXX3NUMSUBMODULES may be deployed as a service, then they may be integrated with an API endpoint, using tools like Flask, FastAPI, or a cloud platform serverless services, and is accessible by a remote user via a network.

In another embodiment, some or all of layers 341, 342, 343 and/or neurons 342, 345, 346, and operations there between such as activations 361, 362, and/or the like, of the LLM agent module 330 and its submodules 331a-232 may be realized via one or more ASICs. For example, each neuron 342, 345 and 346 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the LLM agent module 730 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based code generation module 330 and one or more of its submodules 331a-332 may be trained by iteratively updating the underlying parameters (e.g., weights 351, 352, etc., bias parameters and/or coefficients in the activation functions 361, 362 associated with neurons) of the neural network based on the loss. For example, during forward propagation, the training data such as issue description are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding code patch) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based code generation module 330 and one or more of its submodules 331a-332 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, e.g., see Eq. (3), the boundaries between training and inference are often less distinct compared to supervised learning—in other words, backward propagation and forward propagation may occur for both “training” and “inference” stages of the neural network mode.

In one embodiment, code generation module 330 and its submodules 331a-332 may be housed at a centralized server (e.g., computing device 300) or one or more distributed servers. For example, one or more of code generation module 330 and its submodules 331a-332 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating a code patch resolving a network security issue.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in software engineering.

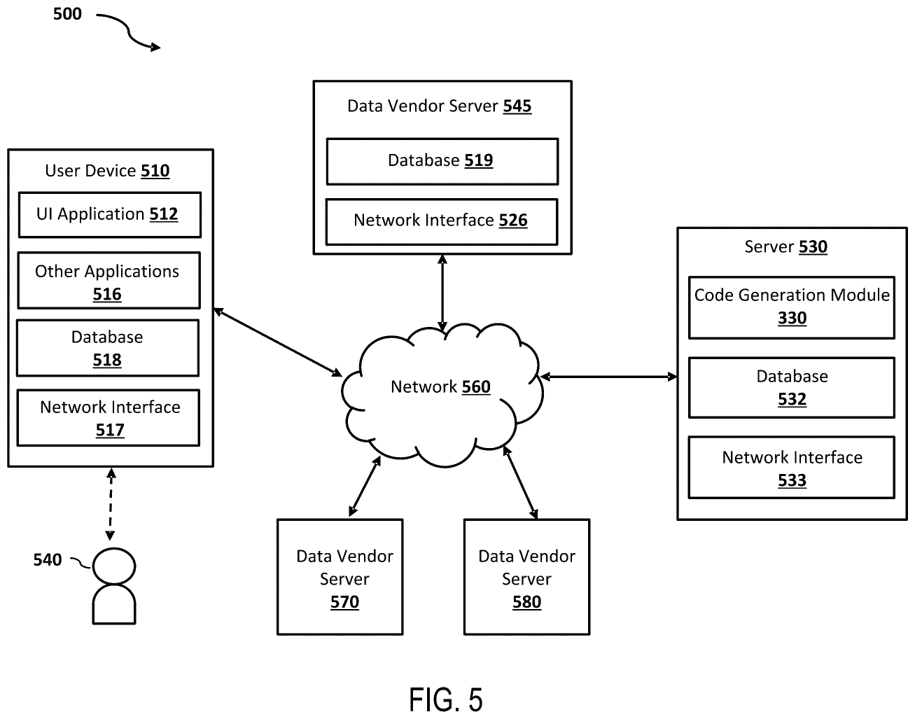

FIG. 5 is a simplified block diagram of a networked system 500 suitable for implementing the code generation framework described in FIGS. 1-4 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating a code patch from the server 530 and display the message via the UI application 512. In other embodiments, user device 510 may include additional or different modules having specialized hardware and/or software as required.

In one embodiment, UI application 512 may communicatively and interactively generate a UI for an AI agent implemented through the code generation module 330 (e.g., an LLM agent) at server 530. In at least one embodiment, a user operating user device 510 may enter a user utterance, e.g., via text or audio input, such as a question, uploading a document, and/or the like via the UI application 512. Such user utterance may be sent to server 530, at which code generation module 330 may generate an output code patch via the process described in FIGS. 1-4. The code generation module 330 may thus cause a display of a code patch at UI application 512 and interactively update the display in real time with the user utterance.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view the generated code patch.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including codebase samples to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the code generation module 330 and its submodules described in FIG. 3. In some implementations, code generation module 230 may receive data from database 519 at the data vendor server 545 via the network 560 to generate a code patch. The generated code patch may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the code generation module 230. In one implementation, the database 532 may store previously generated code patches, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flow

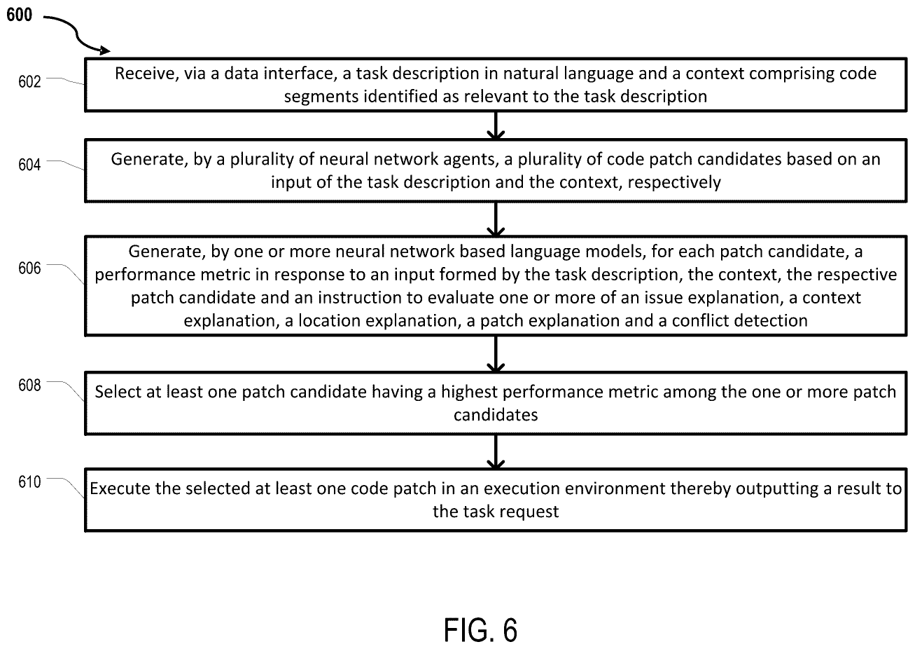

FIG. 6 is an example logic flow diagram illustrating a method of automatically generating a code program for a task request based on the framework shown in FIGS. 1-5, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the code generation module 430 that performs the generation of a code snippet or patch for a software task issue.

As illustrated, the method 600 includes a number of enumerated steps, but aspects of the method 600 may include additional steps before, after, and in between the enumerated steps. In some aspects, one or more of the enumerated steps may be omitted or performed in a different order.

Method 600 starts with step 602, at which a data interface (e.g., 415 in FIG. 4) receives a task description (e.g., 102 in FIG. 1A, 2A) in natural language and a context (e.g., 204 in FIG. 2A) comprising code segments identified as relevant to the task description. For example, the task description may comprise a code debugging request from a code repository running in a code environment as relevant to the task description.

At step 604, a plurality of neural network agents (e.g., 110a-c in FIG. 1A, 2A) may generate a plurality of code patch candidates (e.g., 121a-b, 122a-b, 123 in FIG. 1A) based on an input of the task description and the context, respectively. For example, each of the plurality of neural network agents comprises a language model (e.g., LLM) that is pretrained to retrieve at least a code patch from a code program database (e.g., Github codebase 119) in response to a problem description. The plurality of neural network agents are pretrained to perform different types of coding tasks, e.g., as shown in FIGS. 2B-2C. At least one (e.g., 110a in FIG. 1A) of the plurality of neural network agents may repeatedly generate more than one code patch candidates (e.g., 121a-b in FIG. 1A) based on the input of the task description and the context.

At step 606, one or more neural network based language models (e.g., LLM 130 in FIG. 1A, 2A) for each patch candidate, a performance metric (e.g., score 215 in FIG. 2A) in response to an input formed by the task description, the context, the respective patch candidate and an instruction to evaluate one or more of an issue explanation, a context explanation, a location explanation, a patch explanation and a conflict detection. For example, the performance metric is generated by constructing an input to the one or more neural network language models, the input concatenating the task description (e.g., 102), the context (e.g., 204), a code after inserting the respective code patch (e.g., 208) and a code before inserting the respective code (e.g., 206). The one or more neural network based language models (e.g., LLM 130) may then generate the issue explanation, the context explanation, the location explanation, the patch explanation and the conflict detection in a specific order, based at least on the input combining the respective patch candidate and an instruction, e.g., at least one explanation is generated based on the input and at least one earlier generated explanation. The one or more neural network based language models may further generate a numerical score as the performance metric for the respective code patch.

At step 608, at least one patch candidate (e.g., 216 in FIG. 2A) having a highest performance metric may be selected among the one or more patch candidates.

At step 610, the selected at least one code patch may be executed in an execution environment thereby outputting a result to the task request.

In one embodiment, method 600 and embodiments described in FIGS. 1-4 are applicable in a variety of applications. For example, the task request may be originated from the execution environment of an application, such as an autonomous driving software system, a network traffic management software running at a network gateway, and/or the like.

For example, the issue description 102 received by a neural network model may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing methods and embodiments described in FIGS. 1-6, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 600 disclosed in FIG. 6 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Data Experiment Performance

Data experiments have been conducted to analyze: 1) how diverse are LLM-based SWE agents in terms of intra- and inter-agent diversity?2) To what extent can DEI framework 100 harness the diversity and increase the performances of these SWE agents? In one embodiment,

Example benchmark used in the experiments includes SWE-Bench Lite, a 300-instance subset sampled from the full SWE-Bench for providing a more self-contained evaluation of functional bug fixes Uimenez et al., SWE-bench lite: A canonical subset for efficient evaluation of language models as software engineers, Mar. 19, 2024. URL https://www.swebench.com/lite.html 2024). Compared to the full SWE-Bench, SWE-Bench Lite has significantly more submissions on the leaderboard to conduct a more comprehensive analysis of inter-agent diversity.

Example SWE Agents 101a-101c may include: for intra-agent diversity, three well performing open-source agents on the SWE-Bench Lite leaderboard: Agentless, Moatless, and Aider by running them 10 times with the same parameters; for inter-agent diversity, 10 agents that have similar resolve rates, all between 26.0% and 31.0% on the leaderboard by directly using their submitted patches to the SWE-Bench issues. For the evaluation of DEI FRAMEWORK 100 on different agents 3 groups of agents that are submitted to SWE-Bench Lite, including one group consisting of only open-source agents. For the evaluation of DEI FRAMEWORK 100 on multiple runs of a single agent, generations of the three aforementioned agents are used—Agentless, Moatless Tools, and Aider.

Example evaluation metrics for both intra- and inter-agent diversity as these metrics are defined for multiple candidate solutions without requiring them to come from the same candidate. For example, resolve rate measures how good a SWE agent is. It is defined as the percentage of issues resolved by the agent. This metric measure both single SWE agents and DEI with it to see how much DEI helps.

For another example, Union@k measures the best case performance had the agents been perfectly consistent by counting the number of problems solved by any of the k solutions. In the ideal case where the agents are perfectly consistent, Union@k should be the same as Union@1. Union@k can be considered as the case where we have an oracle reward function R^{oracle} that always selects the correct candidate.

For another example, Intersect@k measures the worst case performance by computing the number of problems solved by all k solutions. The assumption is a problem is only consistently solved if it's always solved. Intersect@k can also be considered as the case where an adversarial reward function R^{adv} is applied that tries to pick an incorrect candidate if there is one.

For another example, Average@k measures the average case performance by computing the average number of problems solved. It corresponds to the case of a random reward function R^{random} that uniformly samples a candidate solution for each problem.

For another example, n@k measures the performance of any reranking mechanism by computing the number of problems solved by n chosen submissions from a total of k samples. The better a reranking mechanism is at telling good solutions from bad ones, the higher n@k is. Note that for an oracle that always picks the correct solution over incorrect ones, n@k is the same as Union@k. For a random reranker that picks a random solution uniformly, n@k is the same as Union@n. In the example, n=1.

Therefore, the gaps between these metrics. Union@k−Intersect@measures how diverse the agents are, while n@k−Average@k measures how much DEI framework 100 helps in selecting the correct candidate. Note that the order—in which different runs are added—matters as k gets larger, especially when the k candidate solutions come from k different agents. In the experiments, candidate solutions are added from the single agent according to the order they are generated, while solutions are added from different agents in a fixed order.

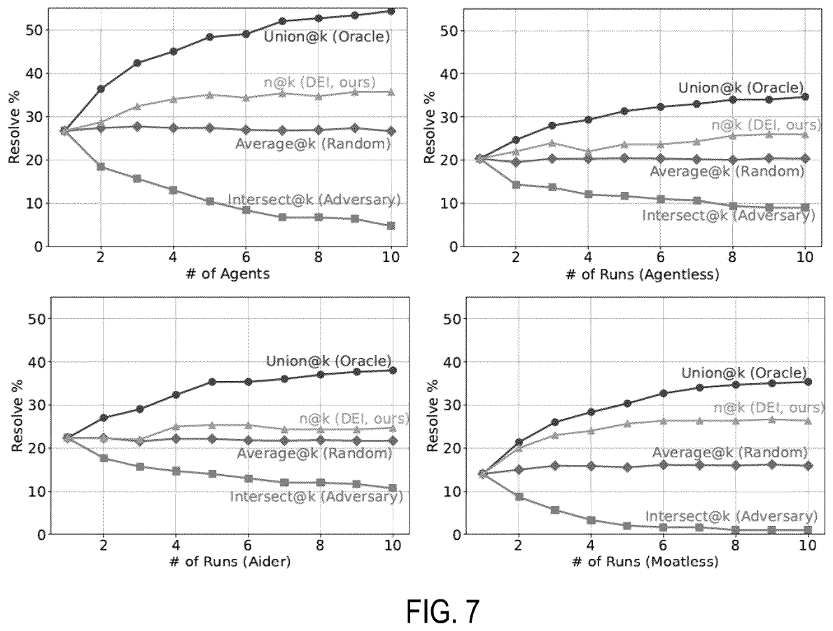

FIG. 7 provide example performance results of the data experiments. As shown in FIG. 7, the “@k” metrics of 10 different agents and 10 runs of single agents are shown. DEI framework 100 is applied to the candidates in FIG. 7 as they are added to the group. For most values of k in all subfigures, we observe a significant improvement of n@k over Average@k, indicating that DEI FRAMEWORK 100 selects correct candidates much better than a random baseline. DEI FRAMEWORK 100 helps more when the candidates come from different agents. This finding resonates with a similar finding from research question one: Since candidates from multiple agents have a larger potential for improvement (Union@k−Average@k), the actual improvements created by DEI FRAMEWORK 100 (n@k−Average@k) are also larger. This suggests that given a limited budget of candi-dates, it would be better to choose a diversity of agents over multiple runs of the same agent.

As k gets larger, DEI FRAMEWORK 100 improvement first increases and then plateaus. While larger k generally indicates higher n@k, the margin gets smaller and there are cases when an increase in k results in a slight drop in performance. This suggests that the current DEI FRAMEWORK 100 is not ideal for a large group of agents and there is still room for a better reranking mechanism.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of automatically generating a code program for a task request, the method comprising:
receiving, via a data interface, a task description in natural language and a context comprising code segments identified as relevant to the task description;
generating, by a plurality of neural network agents, a plurality of code patch candidates based on an input of the task description and the context, respectively;
generating, by one or more neural network based language models, for each patch candidate, a performance metric in response to an input formed by the task description, the context, the respective patch candidate and an instruction to evaluate one or more of an issue explanation, a context explanation, a location explanation, a patch explanation and a conflict detection;
selecting at least one patch candidate having a highest performance metric among the one or more patch candidates; and
executing the selected at least one code patch in an execution environment thereby outputting a result to the task request.

2. The method of claim 1, wherein each of the plurality of neural network agents comprises a language model that is pretrained to retrieve at least a code patch from a code program database in response to a problem description.

3. The method of claim 1, wherein the plurality of neural network agents are pretrained to perform different types of coding tasks.

4. The method of claim 1, wherein at least one of the plurality of neural network agents repeatedly generate more than one code patch candidates based on the input of the task description and the context.

5. The method of claim 1, wherein the performance metric is generated by:
constructing an input to the one or more neural network language models, the input concatenating the task description, the context, a code after inserting the respective code patch and a code before inserting the respective code.

6. The method of claim 1, wherein the performance metric is generated by:
generating by the one or more neural network based language models, the issue explanation, the context explanation, the location explanation, the patch explanation and the conflict detection in a specific order, based at least on the input combining the respective patch candidate and an instruction,
wherein at least one explanation is generated based on the input and at least one earlier generated explanation.

7. The method of claim 1, wherein the performance metric is generated by:
generating, by the one or more neural network based language models, a numerical score as the performance metric for the respective code patch.

8. The method of claim 1, further comprising:
generating, by the one or more neural networks, the task description comprising a code debugging request from a code repository running in a code environment as relevant to the task description.

9. A system of automatically generating a code program for a task request, the system comprising:
a data interface receiving a task description in natural language and a context comprising code segments identified as relevant to the task description;
a memory storing a plurality of processor-readable instructions; and
a processor executing the plurality of processor-readable instructions to perform operations comprising:
generating, by a plurality of neural network agents, a plurality of code patch candidates based on an input of the task description and the context, respectively;
generating, by one or more neural network based language models, for each patch candidate, a performance metric in response to an input formed by the task description, the context, the respective patch candidate and an instruction to evaluate one or more of an issue explanation, a context explanation, a location explanation, a patch explanation and a conflict detection;
selecting at least one patch candidate having a highest performance metric among the one or more patch candidates; and
executing the selected at least one code patch in an execution environment thereby outputting a result to the task request.

10. The system of claim 9, wherein each of the plurality of neural network agents comprises a language model that is pretrained to retrieve at least a code patch from a code program database in response to a problem description.

11. The system of claim 9, wherein the plurality of neural network agents are pretrained to perform different types of coding tasks.

12. The system of claim 9, wherein at least one of the plurality of neural network agents repeatedly generate more than one code patch candidates based on the input of the task description and the context.

13. The system of claim 9, wherein the performance metric is generated by:
constructing an input to the one or more neural network language models, the input concatenating the task description, the context, a code after inserting the respective code patch and a code before inserting the respective code.

14. The system of claim 9, wherein the performance metric is generated by:
generating by the one or more neural network based language models, the issue explanation, the context explanation, the location explanation, the patch explanation and the conflict detection in a specific order, based at least on the input combining the respective patch candidate and an instruction,
wherein at least one explanation is generated based on the input and at least one earlier generated explanation.

15. The system of claim 9, wherein the performance metric is generated by:
generating, by the one or more neural network based language models, a numerical score as the performance metric for the respective code patch.

16. The system of claim 9, wherein the operations further comprise:
generating, by the one or more neural networks, the task description comprising a code debugging request from a code repository running in a code environment as relevant to the task description.

17. A non-transitory processor-readable medium storing a plurality of processor-executable instructions for automatically generating a code program for a task request, the instructions being executed by a processor to perform operations comprising:
receiving, via a data interface, a task description in natural language and a context comprising code segments identified as relevant to the task description;
generating, by a plurality of neural network agents, a plurality of code patch candidates based on an input of the task description and the context, respectively;
generating, by one or more neural network based language models, for each patch candidate, a performance metric in response to an input formed by the task description, the context, the respective patch candidate and an instruction to evaluate one or more of an issue explanation, a context explanation, a location explanation, a patch explanation and a conflict detection;
selecting at least one patch candidate having a highest performance metric among the one or more patch candidates; and
executing the selected at least one code patch in an execution environment thereby outputting a result to the task request.

18. The medium of claim 17, wherein each of the plurality of neural network agents comprises a language model that is pretrained to retrieve at least a code patch from a code program database in response to a problem description.

19. The medium of claim 17, wherein the performance metric is generated by:
constructing an input to the one or more neural network language models, the input concatenating the task description, the context, a code after inserting the respective code patch and a code before inserting the respective code;
generating, by the one or more neural network based language models, the issue explanation, the context explanation, the location explanation, the patch explanation and the conflict detection in a specific order, based at least on the input combining the respective patch candidate and an instruction,
wherein at least one explanation is generated based on the input and at least one earlier generated explanation; and
generating, by the one or more neural network based language models, a numerical score as the performance metric for the respective code patch.

20. The medium of claim 1, wherein the operations further comprise:
generating, by the one or more neural networks, the task description comprising a code debugging request from a code repository running in a code environment as relevant to the task description.
